(19) United States
(12) Patent Application Publication
(10) Pub. No.: US 2024/0217347 A1
(43) Pub. Date: Jul. 4, 2024

(54) ENERGY TRANSMISSION IN A LINEAR TRANSPORT SYSTEM

(71) Applicant: Beckhoff Automation GmbH, Verl (DE)

(72) Inventors: Andreas Brinker, Bakum (DE); Thomas Vorbohle, Rietberg (DE); Jan Achterberg, Duisburg (DE)

(21) Appl. No.: 18/603,772

(22) Filed: Mar. 13, 2024

Related U.S. Application Data
(63) Continuation of application No. PCT/EP2022/075753, filed on Sep. 16, 2022.

(30) Foreign Application Priority Data
Sep. 17, 2021 (DE) 10 2021 124 121.9

(51) Int. Cl. B60L 13/03; H02P 7/02; H02P 29/68; H02P 101/40

(52) U.S. Cl. CPC B60L 13/03; H02P 7/02; H02P 29/68; B60L 2200/26; H02P 2101/40

(57) ABSTRACT

A method is disclosed for transmitting energy from a stationary unit to a movable unit of a linear transport system. The linear transport system includes a guide rail, a plurality of stationary units, and a linear motor for driving the movable unit along the guide rail. The linear motor includes a stator and a rotor, the stator including the stationary units, each having one or more drive coils. The rotor is arranged on the movable unit and incudes one or more magnets. The stationary units each have one or more energy-transmitting coils, each energy-transmitting coil including actuation electronics. The movable unit has at least one energy-receiving coil. The actuation electronics carry out the following steps: reading in an energy quantity signal for the energy-transmitting coil concerned, converting the energy quantity signal into a pulse-pause ratio for actuating the energy-transmitting coil, and actuating the energy-transmitting coil based on the pulse-pause ratio.

### CROSS-REFERENCE TO RELATED APPLICATIONS

This patent application is a continuation of International Patent Application No. PCT/EP2022/075753 filed Sep. 16, 2022, “Energy Transfer in a Linear Transport System,” which claims the priority of German patent application DE 10 2021 124 121.9 filed Sep. 17, 2021, “Energieübertragung in einem linearen Transportsystem,” each of which is incorporated by reference herein, in the entirety and for all purposes.

### FIELD

This application relates to a method for transmitting energy from a stationary unit of a linear transport system to a movable unit of a linear transport system, and to a linear transport system.

### BACKGROUND

Linear transport systems are known from the prior art, in which a movable unit may be moved along a guide rail and which comprise a linear motor for driving the movable unit. The linear motor comprises a stator and a rotor. The stator may comprise at least one motor module arranged in a stationary manner along the guide rail and having one or a plurality of drive coils, while the movable unit is arranged on a carriage and may comprise one or a plurality of magnets. By energizing the drive coils, a force may be generated acting upon the magnets of the movable unit in such a way that the movable unit moves along the guide rail.

It may further be provided that the movable unit or carriage includes a tool, wherein energy must be transmitted from the stationary unit to the movable unit in order to operate the tool. Furthermore, it may be necessary to transmit data both from the stationary unit to the movable unit and from the movable unit to the stationary unit. German patent application DE 10 2018 111 715 A1 dated 16 May 2018 discloses such a linear transport system providing an energy transmission between a stationary coil module, i.e. a stationary unit, and a movable carriage, i.e. a movable unit. German patent application 10 2020 107 782.3 dated 20 Mar. 2020 also discloses an energy transmission in a linear transport system in which energy-transmitting coils are selected on the basis of a position of the movable unit and an energy-receiving coil arranged on the movable unit, and are energized on the basis of an energy quantity signal.

### SUMMARY

The invention provides an improved method for transmitting energy from a stationary unit to a movable unit of a linear transport system. The invention provides a linear transport system in which an energy transmission is possible.

According to a first aspect, a method for transferring energy from a stationary unit to a movable unit of a linear transport system is provided. The linear transport system comprises a guide rail for guiding the movable unit, a plurality of stationary units as well as a linear motor for driving the movable unit along the guide rail, the linear motor comprising a stator and a rotor, the stator including the stationary units each comprising one or a plurality of drive coils, the rotor being arranged on the movable unit and comprising one or a plurality of magnets, the stationary units each comprising one or a plurality of energy-transmitting coils, each energy-transmitting coil having an actuation electronics, the movable unit comprising at least one energy-receiving coil. The actuation electronics of the energy-transmitting coils carries out the following steps: reading in an energy quantity signal for the relevant energy-transmitting coil; converting the energy quantity signal into a pulse-pause ratio for actuating the energy-transmitting coil; and actuating the energy-transmitting coil based on the pulse-pause ratio.

According to a second aspect, a method for transferring energy from a stationary unit to a movable unit of a linear transport system is provided. The linear transport system comprising a guide rail for guiding the movable unit, a plurality of stationary units, a controller as well as a linear motor for driving the movable unit along the guide rail, the linear motor comprising a stator and a rotor, the stator including the stationary units each comprising one or a plurality of drive coils, the rotor being arranged on the movable unit and comprising one or a plurality of magnets, the stationary units each comprising one or a plurality of energy-transmitting coils, each energy-transmitting coil having an actuation electronics, the movable unit comprising at least one energy-receiving coil.

The controller carries out the following steps:
detecting position data of the energy-receiving coil of the movable unit, selecting energy-transmitting coils of the stationary units on the basis of the position data of the energy-receiving coil of the movable unit, and
outputting an energy quantity signal to the actuation electronics of the selected energy-transmitting coils.

The actuation electronics of the selected energy-transmitting coils carries out the following steps:
reading in the energy quantity signal for the relevant energy-transmitting coil,
converting the energy quantity signal into a pulse-pause ratio for actuating the energy-transmitting coil with the aid of a counter, and
actuating the energy-transmitting coil based on the pulse-pause ratio in order to control a current through the energy-transmitting coil.

If the position data of the energy-receiving coil of the movable unit determined by the controller reveal that the energy-receiving coil of the movable unit moves away from a first energy-transmitting coil to a second energy-transmitting coil, wherein the energy quantity signal is output to a first actuation electronics of the first energy-transmitting coil and to a second actuation electronics of the second energy-transmitting coil and the first actuation electronics of the first energy-transmitting coil and the second actuation electronics of the second energy-transmitting coil are each synchronized on the basis of a synchronization signal of the controller, wherein a first counter of the first actuation electronics and a second counter of the second actuation electronics are started simultaneously on the basis of a synchronization signal.

According to a third aspect, a linear transport system comprises at least one stationary unit and at least one movable unit, and a controller, wherein the linear transport system comprises a guide rail for guiding the movable unit, a plurality of stationary units, and a linear motor for driving the movable unit along the guide rail, the linear motor comprising a stator and a rotor, the stator comprising the stationary units, each comprising one or a plurality of drive coils, the rotor being arranged on the movable unit and comprising one or a plurality of magnets, the stationary units each comprising one or a plurality of energy-transmitting coils, each energy-transmitting coil comprising an actuation electronics, the movable unit comprising at least one energy-receiving coil.

The controller is set up to determine position data of the energy-receiving coil of the movable unit, to select energy-transmitting coils of the stationary units on the basis of the position data of the energy-receiving coil of the movable unit, and to output an energy quantity signal to the actuation electronics of the selected energy-transmitting coils. The actuation electronics is set up to read in an energy quantity signal for the relevant energy-transmitting coil, to convert the energy quantity signal it into a pulse-pause ratio and to actuate the energy-transmitting coil on the basis of the pulse-pause ratio in order to control a current through the energy-transmitting coil.

If the position data of the energy-receiving coil of the movable unit determined by the controller reveal that the energy-receiving coil of the movable unit moves away from a first energy-transmitting coil to a second energy-transmitting coil, wherein the energy quantity signal is output to a first actuation electronics of the first energy-transmitting coil and to a second actuation electronics of the second energy-transmitting coil and the first actuation electronics of the first energy-transmitting coil and the second actuation electronics of the second energy-transmitting coil are each synchronized on the basis of a synchronization signal of the controller, wherein a first counter of the first actuation electronics and a second counter of the second actuation electronics are started simultaneously on the basis of a synchronization signal.

### EXAMPLES

A linear transport system includes a guide rail for guiding a movable unit, a plurality of stationary units, and a linear motor for driving the movable unit along the guide rail. The linear motor comprises a stator and a rotor, the stator including the stationary units each having one or a plurality of drive coils. The rotor is arranged on the movable unit and comprises one or a plurality of magnets, the stationary units each comprising one or a plurality of energy-transmitting coils, each energy-transmitting coil comprising an actuation electronics. The movable unit comprises at least one energy-receiving coil.

In order to transmit energy from the stationary unit to the movable unit of the linear transport system, the actuation electronics of the energy-transmitting coils carry out the steps described below. An energy quantity signal is read in for the energy-transmitting coil in question. The energy quantity signal is then converted into a pulse-pause ratio and the energy-transmitting coil is controlled on the basis of the pulse-pause ratio. Actuation may also include closed-loop control, so that a current through the energy-transmitting coil may be close-loop-controlled on the basis of the energy quantity signal and the counter.

In principle, it is also conceivable to use the described method in order to transmit energy from the movable unit to the stationary unit, with the energy-receiving coil then transmitting the energy and the energy-transmitting coil receiving the energy.

In an embodiment, the energy quantity signal is converted into the pulse-pause ratio with the aid of a counter. The pulse-pause ratio is used to control a current through the energy-transmitting coil.

It may be provided that the energy quantity signal is linked with a value of the counter and, for example, a switch linked with the energy-transmitting coil is switched to conductive for certain counter values and to non-conductive for other counter values. The counter values for which the switch is switched to conductive or non-conductive may be determined from the energy quantity signal. This method allows for simple control of the energy-transmitting coil.

For example, the switch may be made conductive each time the counter is above a counter value calculated from the energy quantity signal.

### BRIEF DESCRIPTION OF THE DRAWINGS

The invention is described in more detail with reference to the accompanying figures, which show:

FIG. 1 shows a linear transport system;

FIG. 2 shows a lateral top view of a section of the linear transport system of FIG. 1;

FIG. 3 shows a circuit diagram for controlling energy-transmitting coils;

FIG. 4 shows a data transmission for actuation;

FIG. 5 shows an actuation electronics;

FIG. 6 shows a first actuation of an energy-transmitting coil;

FIG. 7 shows a second actuation of an energy-transmitting coil;

FIG. 8 shows a temperature curve diagram;

FIG. 9 shows a stationary unit and a movable unit of a linear transport system;

FIG. 10 shows an electrical circuit of a movable unit; and

FIG. 11 shows a third actuation of an energy-transmitting coil.

In the following, the same reference numerals may be used for the same features. Furthermore, for reasons of clarity, it may be provided that not all elements are shown in each figure. Furthermore, for the sake of clarity, it may be provided that not every element is provided with its own reference numeral in every drawing.

### DETAILED DESCRIPTION

In an embodiment, the actuation electronics of the energy-transmitting coil comprises at least a first half-bridge having a first switch and a second switch and a second half-bridge having a third switch and a fourth switch. The energy-transmitting coil is arranged between a first half-bridge center and a second half-bridge center, wherein the first half-bridge center is arranged between the first switch and the second switch and the second half-bridge center is arranged between the third switch and the fourth switch.

In this context, it may be provided that the first switch and the third switch are connected to a first terminal of a voltage source, and the second switch and the fourth switch are connected to a second connection of a voltage source. In each case, the counter counts up from a minimum value to a maximum value and then counts down from the maximum value to the minimum value. Subsequently, it may be provided that this counting process is repeated when counting back up to the maximum when the minimum is reached and then counting back down from the maximum. The energy quantity signal is associated with an upper counter value and a lower counter value. The first switch and the fourth switch are switched to conductive when the counter is above the upper counter value, and the second switch and the third switch are switched to conductive when the counter is below the lower counter value.

Due to the half-bridges and the manner of counting, the energy-transmitting coil may thus be supplied with current flow in a first current flow direction when the counter is above the upper counter value, and with current flow in a direction opposite to the first current flow direction when the counter is below the lower counter value. This allows for improved actuation of the energy-transmitting coils.

In an embodiment, a nominal power is to be transmitted. Then, the upper counter value is larger than three quarters of a difference of maximum value and minimum value plus the minimum value. The lower counter value is less than one quarter of the difference between the maximum value and the minimum value plus the minimum value.

Thus, if the nominal power is to be transmitted, this method achieves that less than a quarter of the counter run time the energy-transmitting coil is operated in the first current flow direction, subsequently the coil is not energized for more than a quarter of the counter run time, subsequently the energy-transmitting coil is operated for less than a quarter of the counter run time in the second current flow direction and subsequently the energy-transmitting coil is not energized for more than a quarter of the counter run time. This allows for efficient actuation.

In an embodiment, for the transmission of the nominal power, the upper counter value is at least seven eighths of the difference between the maximum value and the minimum value plus the minimum value, and the lower counter value is at most one eighth of the difference between the maximum value and the minimum value plus the minimum value. This allows for reducing a thermal load on the energy transmission since the energy-transmitting coil is energized for a lesser amount of time.

In an embodiment, for transmitting a peak power exceeding the nominal power, the upper counter value is at least three quarters of the difference between the maximum value and the minimum value plus the minimum value, and the lower counter value is at most one quarter of the difference between the maximum value and the minimum value plus the minimum value.

The peak power may be transmitted in particular when large amounts of energy are required at the movable unit. In particular, it may be provided that the peak power is not transmitted permanently, but only for predefined periods of time, and that the transmission power is then reduced again in order to prevent a thermal load on the energy-transmitting coil or the actuation electronics. In particular, this may be the case if, for the transmission of the nominal power, the upper counter value is at least seven eighths of the difference between the maximum value and the minimum value plus the minimum value and the lower counter value is at most one eighth of the difference between the maximum value and the minimum value plus the minimum value.

If the minimum value is zero, the underlying equations may be simplified.

In an embodiment, a data transmission signal is also read in by the actuation electronics. The data transmission signal implies that a data transmission is taking place in the region of the energy-transmitting coil. In this case, at least once when the counter is above the upper counter value, the first switch and the fourth switch are switched non-conductive, and at least once when the counter is below the lower counter value, the second switch and the third switch are switched non-conductive. This is particularly useful when a data transmission could be disrupted by the transmission of energy and the safety of the data transmission takes precedence over the transmitted energy. By then switching off the energy-transmitting coils, a quality of the data transmission may be improved.

In an embodiment of the method, a controller additionally outputs a synchronization signal to the actuation electronics of the energy-transmitting coils. The actuation electronics synchronize the counters on the basis of the synchronization signal. This makes it possible to synchronize an energy transmission with different energy-transmitting coils accordingly. This may be done, for example, with the aid of a PLL in each actuation electronics.

In an embodiment of the method, a controller determines position data of the energy-receiving coil of the movable unit and selects at least one energy-transmitting coil within the linear transport system based on the position data of the energy-receiving coil. An energy quantity signal is then output to the actuation electronics of the selected energy-transmitting coils. This makes it possible to control the energizing of the energy-transmitting coils in such a way that energy-transmitting coils are energized only where movable units and thus energy-receiving coils may also be located.

In an embodiment of the method, the position data of the energy-receiving coil of the movable unit results in the energy-receiving coil moving from a first energy-transmitting coil to a second energy-transmitting coil. A first actuation electronics of the first energy-transmitting coil and a second actuation electronics of the second energy-transmitting coil are respectively synchronized based on the synchronization signal. A first counter of the first actuation electronics and a second counter of the second actuation electronics are started simultaneously based on the synchronization signal. The energy quantity signal is output to the first actuation electronics and the second actuation electronics, wherein the actuation electronics associate the energy quantity signal with an upper counter value and a lower counter value.

The first switch and the fourth switch of the first actuation electronics are switched to conductive when the counter is above the upper counter value. The second switch and the third switch of the first actuation electronics are switched on when the counter is below the lower counter value. The first switch and the fourth switch of the second actuation electronics are switched on when the counter is above the upper counter value, and the second switch and the third switch of the second actuation electronics are switched on when the counter is below the lower counter value. This allows for synchronously operating the first energy-transmitting coil and the second energy-transmitting coil so that the movable unit may be moved from the first energy-transmitting coil to the second energy-transmitting coil with as little interference as possible.

In an embodiment, the position data reveal that the energy-receiving coil is located between the first energy-transmitting coil and the second energy-transmitting coil. In this case, the upper counter value is reduced and the lower counter value is increased. If the energy-receiving coil is located between the first energy-transmitting coil and the second energy-transmitting coil, there is no ideal coupling between the energy-transmitting coils and the energy-receiving coil. By reducing the upper counter value and increasing the lower counter value, the amount of energy transmitted via the energy-transmitting coils is now increased so that the reduced coupling may be balanced.

In particular, this may be carried out in such a way that the movable unit moves from the first energy-transmitting coil to the second energy-transmitting coil and the energy-receiving coil receives a constant amount of energy. This particularly means that for the energy-receiving coil it is not necessary to distinguish whether during the entire energy transmission the energy-receiving coil was coupled to one energy-transmitting coil or to two energy-transmitting coils and the energy was transmitted via one energy-transmitting coil or via two energy-transmitting coils.

In an embodiment, a thermal load of the power transmission is additionally determined for the case that a power larger than the nominal power is to be transmitted. Furthermore, a cooling-off time is calculated. A renewed reduction of the upper counter value and a renewed increase of the lower counter value in such a way that a power larger than the nominal power may be transmitted is only carried out after the cooling-off time. This makes it possible to avoid thermal stress on the power transmission or the power transmitter coils and actuation electronics.

In an embodiment, an energizing of the drive coils is changed in such a way that the movable unit moves faster. This makes it possible, in particular, if the amount of energy transmission must be increased due to the movement of the energy-receiving coil from the first energy-transmitting coil to the second energy-transmitting coil, to move the movable unit more quickly in this area and thereby to reduce the duration of the increased energy transmission. Furthermore, if the movable unit and thus the energy-receiving coil is arranged exclusively in the region of the first energy-transmitting coil or exclusively in the region of the second energy-transmitting coil, a drive current may be reduced accordingly in order to maintain a predetermined average speed of the movable unit in total.

In an embodiment, an increase time duration during which the energization of the drive coil is changed is calculated from a speed of the movable unit. Thus, the increase time duration is the time during which the movable unit is moved faster.

In an embodiment, the upper counter value and the lower counter value are adjusted based on a temperature measured in the area of the energy-transmitting coil. This may be used in particular to avoid a thermal overload of the energy-transmitting coil or the actuation electronics. If the measured temperature is above a critical temperature, the upper counter value may in particular be increased and the lower counter value may be reduced so that a transmitted amount of energy decreases, but a thermal load on the energy-transmitting coil and the actuation electronics is prevented.

The invention further comprises a linear transport system having at least one stationary unit and at least one movable unit, and a controller. The linear transport system comprises a guide rail for guiding the movable unit, a plurality of stationary units, and a linear motor for driving the movable unit along the guide rail. The linear motor includes a stator and a rotor. The stator includes the stationary units, each of which includes one or a plurality of drive coils. The rotor is arranged on the movable unit and includes one or a plurality of magnets. The stationary units each comprise one or a plurality of energy-transmitting coils. Each energy-transmitting coil is assigned an actuation electronics. The movable unit comprises at least one energy-receiving coil. The actuation electronics are set up to read in an energy quantity signal for the relevant energy-transmitting coil, in particular to read in an energy quantity signal transmitted by the controller, to convert it into a pulse-pause ratio and to drive the energy transmitting pulses on the basis of the pulse-pause ratio.

In an embodiment, the actuation electronics is set up to convert the energy quantity signal into a pulse-to-pause ratio with the aid of a counter, wherein a current through the energy-transmitting coil is controlled based on the pulse-to-pause ratio.

In an embodiment, the movable unit of the linear transport system comprises a smoothing capacitor.

The invention further comprises actuation electronics and controllers set up to carry out the method according to the invention and, in addition, computer programs for carrying out the method.

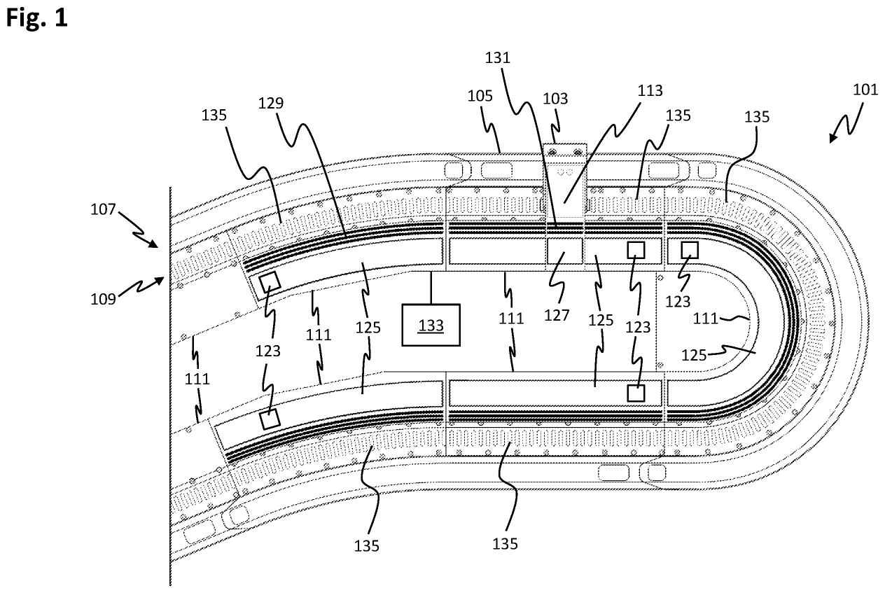

FIG. 1 shows a section of a linear transport system 101. The linear transport system 101 comprises a movable unit 103 guided by a guide rail 105. The movable unit 103 includes track rollers and a rotor 113 with magnets. In this regard, the track rollers of the movable unit 103 may roll on running surfaces of the guide rail 105.

The linear transport system 101 further comprises a linear motor 107, the linear motor 107 having a stator 109. The stator 109 of the linear motor 107 is arranged in the stationary units 111, each of which comprises a plurality of drive coils 135 for this purpose. In this context, the stationary units 111 in FIG. 1 are partially configured differently, and individual ones of the stationary units 111 may be straight or curved. The linear motor 107 further comprises the rotor 113, which is arranged on the movable unit 103 and comprises one or a plurality of magnets. The stationary units 111 each comprise an energy-transmitting coil 125. The movable unit 103 comprises an energy-receiving coil 127. In an alternative embodiment, a stationary unit 111 may also comprise a plurality of energy-transmitting coils 125. The stationary units 111 and the guide rail 105 may be arranged circumferentially so that the movable unit 103 may be moved along a closed path.

Each stationary unit 111 further comprises actuation electronics 123 that may be used to control a current flowing through the energy-transmitting coil 125. The linear transport system 101 further comprises a controller 133 directly connected to one of the stationary units 111. A data signal from the controller 133 may be forwarded from one stationary unit 111 to the next stationary unit 111. Alternatively, embodiments in which the controller 133 is directly connected to each stationary unit 111 or to a subset of the stationary units 111 are also conceivable. In this case, the actuation electronics 123 of the stationary units 111 may, in particular, receive data signals from the controller 133 and use these control signals to control the energy-transmitting coils 125.

The stationary units 111 further comprise optional stationary antennas 129. The movable unit 103 comprises an optional movable antenna 131. The movable antenna 131 is fixed to the movable unit 103, thus may move along the guide rail 105 together with the movable unit 103. With the aid of the stationary antennas 129 and the movable antenna 131, data may be exchanged between the stationary units 111 and the movable unit 103. Alternatively, however, such data transmission may also be embodied, for example, with the aid of a wireless WLAN or Bluetooth or an infrared connection or a 5G connection or according to the DECT standard or as optical transmission.

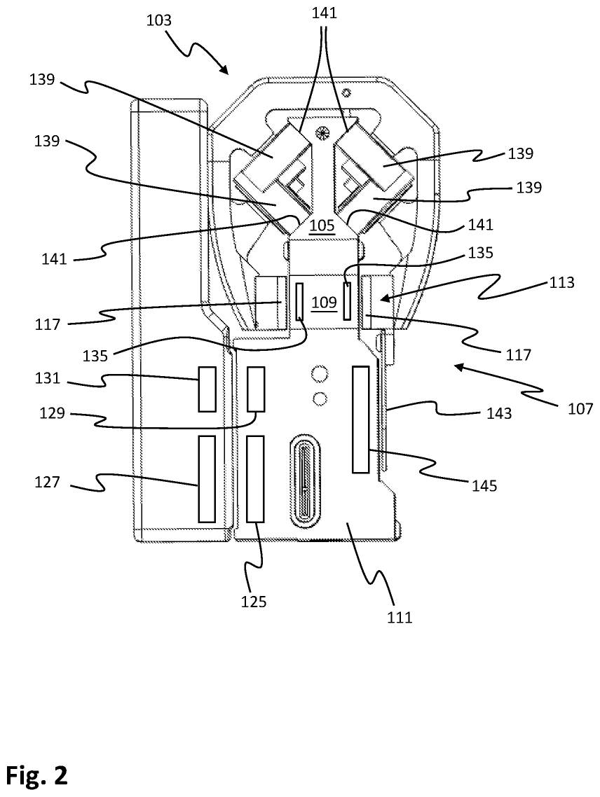

FIG. 2 shows a lateral top view of a stationary unit 111 including a guide rail 105, on which a movable unit 103 is arranged. Guidance of the movable unit 103 may also be provided with the aid of alternative embodiments. Track rollers 139 of the movable unit 103 may roll on track surfaces 141 of the guide rail 105, allowing substantially one-dimensional movement of the movable unit 103 along the guide rail 105.

Also shown in FIG. 2 are magnets 117 of the movable unit 103, which form the rotor 113 of the linear motor 107. Furthermore, drive coils 135 are shown in the area of the stator 109. In contrast to the illustration of FIG. 2, it may also be provided that the magnets 117 are arranged only on one side of the drive coil 135. Below the magnets 117 and the stator 109, the movable unit 103 comprises a position detection element 143 on one side.

The stationary unit 111 comprises a position sensor 145 in this area. The position sensor 145 may measure, for example, an induction behavior of a coil changed by a metal piece embedded in the position detection element 143. For this purpose, the position sensor 145 may e.g. comprise an energized coil in which a change in inductance caused by a passing position detection element 143 leads to a change in current in the coil, and thus the position of the position detection element 143 and thus the movable unit 103 may be detected. However, the position sensor 145 may of course also be configured differently, for example with an excitation coil and a receiving coil respectively, with the aid of which an inductance of the metal piece embedded in the position detection element 143 may also be measured. Furthermore, magnets embedded in the position detection element 143 or a light barrier evaluation for position determination are also conceivable, for example.

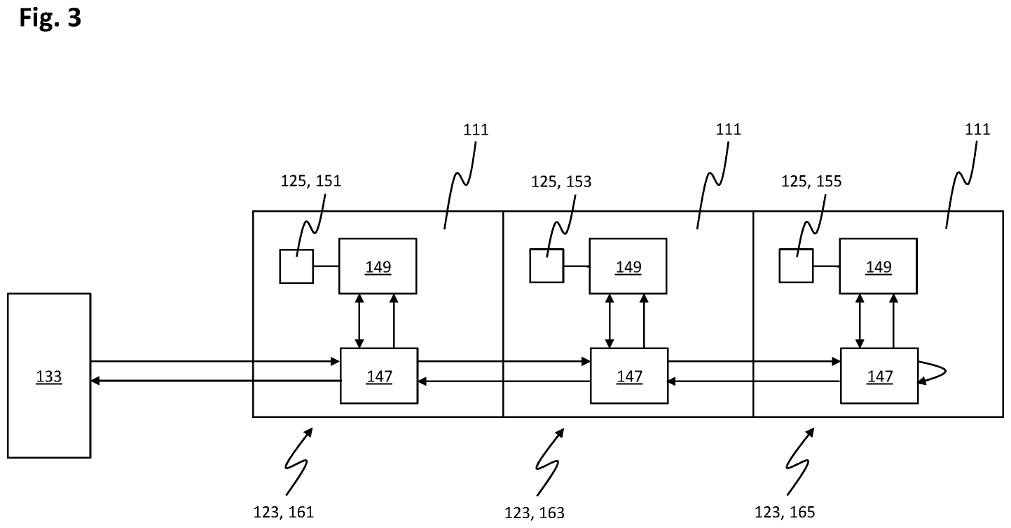

FIG. 3 shows a data communication within a linear transport system 101. Three stationary units 111 are schematically shown, each stationary unit 111 comprising actuation electronics 123 and an energy-transmitting coil 125. The actuation electronics 123 are used to drive the energy-transmitting coil 125.

It may be provided that each stationary unit 111 also comprises more than one actuation electronics 123 and more than one energy-transmitting coil 125 associated therewith, wherein the basic principle of data transmission remains identical. In this case, the actuation electronics 123 comprise a communication interface 147 and a coil actuation 149. The stationary units 111 may further comprise control elements integrated into the coil actuation 149 or additionally provided for controlling the drive coils 135. The coil actuation 149 thus relates exclusively to the control of the energy-transmitting coils 125, as the case may be.

Three stationary units 111 are shown in FIG. 3. Here, a total of a first energy-transmitting coil 151 having a first actuation electronics 161, a second energy-transmitting coil 153 having a second actuation electronics 163 and a third energy-transmitting coil 155 having a third actuation electronics 165 are provided.

Data signals from the controller 133 may be communicated to the coil actuation 149 via the communication interfaces 147. The data communication between the controller 133 and the communication interfaces 147 may be carried out, for example, with the aid of the EtherCAT protocol. The actuation electronics 123 may also be set up to control further elements of the stationary units 111, such as drive coils 135 or the position detection element 143.

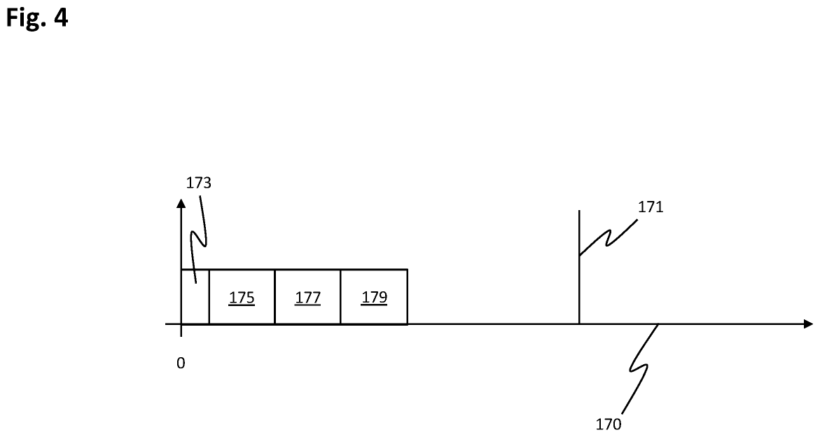

FIG. 4 shows a data flow of such a data communication plotted over a time 170. A header frame 173, a first data frame 175 for the first actuation electronics 161, a second data frame 177 for the second actuation electronics 163 and a third data frame 179 for the third actuation electronics 165 are output. Furthermore, an interrupt signal 171 may be output with the aid of which all actuation electronics 123 may be synchronized. The interrupt signal 171 may be used, for example, to operate a PLL of each of the first actuation electronics 161, the second actuation electronics 163 and the third actuation electronics 165.

In order to drive the energy-transmitting coils 125, the actuation electronics 123 may carry out the following steps. First, an energy quantity signal may be read in for the energy-transmitting coil 125 in question. This energy quantity signal may be provided by the controller 133, for example. The energy quantity signal is then converted into a pulse-pause ratio by the actuation electronics 123, and the energy-transmitting coil 125 is controlled based on the pulse-pause ratio. The pulse-pause ratio may be determined, for example, with the aid of a clock or by evaluating a predetermined oscillation, for example in a resonant circuit.

In an embodiment example, a counter is started in the actuation electronics 123, in particular in the coil actuation 149, and the conversion of the energy quantity signal into the pulse-pause ratio is carried out by the counter.

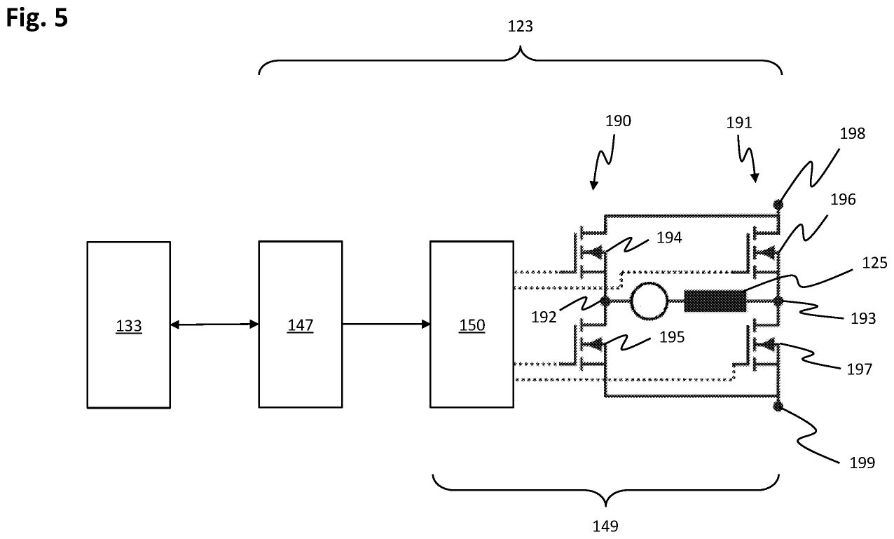

FIG. 5 schematically shows how the energy-transmitting coils 125 may be actuated electronically. A data signal originating from the controller 133 is processed by the actuation electronics 123. In particular, the data signal is received by the communication interface 147 and forwarded to the coil actuation 149.

In this regard, the coil actuation 149 comprises a driver 150 and a first half-bridge 190 and a second half-bridge 191. The first half-bridge 190 comprises a first half-bridge center point 192, and the second half-bridge 191 comprises a second half-bridge center point 193. The energy-transmitting coil 125 is arranged between the first half-bridge center point 192 and the second half-bridge center point 193. The first half-bridge 190 further comprises a first switch 194 and a second switch 195, the first half-bridge center 192 being arranged between the first switch 194 and the second switch 195. The second half-bridge 191 comprises a third switch 196 and a fourth switch 197, wherein the second half-bridge center 193 is arranged between the third switch 196 and the fourth switch 197.

Furthermore, as shown in FIG. 5, the first switch 194 and the third switch 196 may be connected to a potential 198, while the second switch 195 and the fourth switch 197 are connected to a common ground point 199. Depending on the position of the first through fourth switches 194, 195, 196, 197, a current may flow through the energy-transmitting coil 125. In particular, the first switch 194 and the fourth switch 197 or the second switch 195 and the third switch 196 are simultaneously rendered conductive by the coil actuation 149 so as to guide a current forward or backward through the energy-transmitting coil 125.

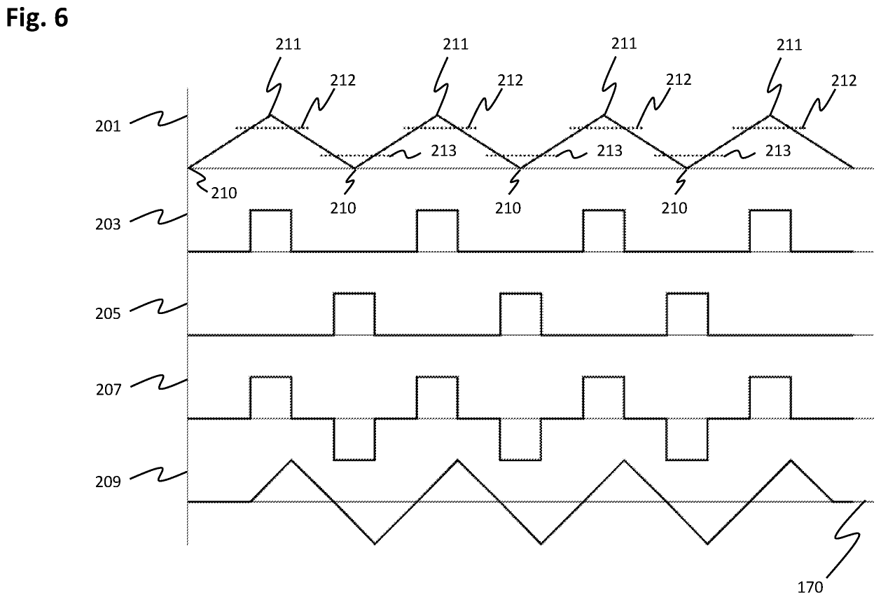

FIG. 6 shows process sequences for a counter 201, a first switching signal curve 203 of the first switch 194 and the fourth switch 197, a second switching signal curve 205 of the second switch 195 and the third switch 196, an applied coil voltage 207 resulting from the first switching signal curve 203 and the second switching signal curve 205, and a coil current 209, in each case plotted over time 170. The coil current 209 is shown as ideal and without further losses.

In each case, the counter 201 counts up from a minimum value 210 to a maximum value 211 and then counts down from the maximum value 211 back to the minimum value 210. The energy quantity signal transmitted by the controller 133 is linked to an upper counter value 212 and a lower counter value 213. If the counter 201 is above the upper counter value 212, the first switch 194 and the fourth switch 197 are switched to conductive, which may be seen from the first switching signal curve 203. If the counter 201 is below the lower counter value 213, the second switch 195 and the third switch 196 are switched to conductive, which may be seen from the second switching signal curve 205.

Since, due to the actuation with the aid of the first half-bridge 190 and the second half-bridge 191, the voltage applied to the energy-transmitting coil 125 is reversed in each case, this results in the course of the applied coil voltage 207. The ideal coil current 209 results from this applied coil voltage 207. In this context, FIG. 6 shows the maximum possible actuation with applied coil voltage 207 at 50 percent of the time.

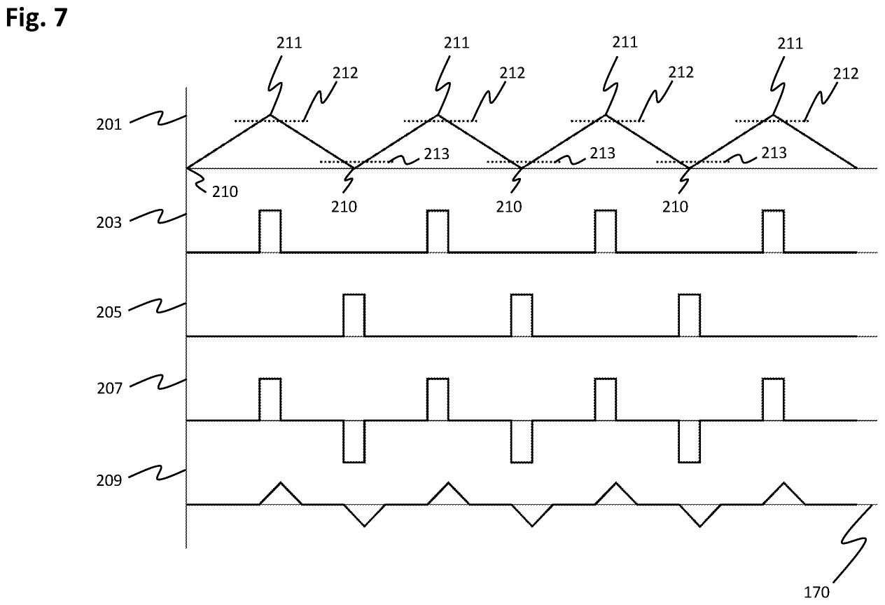

FIG. 7 shows a curve of the counter 201, the first switching curve 203, the second switching curve 205, the coil voltage 207 and the coil current 209 for the case in which the upper counter value 212 is increased and the lower counter value 213 is decreased. In this case, a power is transmitted with the aid of the energy-transmitting coil 125 that is smaller than the power of the energy transmission shown in FIG. 6, which is caused in particular by the shortened switching pulses of the applied coil voltage 207 and results in a smaller effective coil current 209.

In an embodiment example, a nominal power is to be transmitted. Then, the upper counter value 212 may be larger than three quarters of a difference of maximum value 211 and minimum value 210 plus the minimum value 210. The lower counter value 213 may be less than one-fourth of a difference of the maximum value 211 and the minimum value 210 plus the minimum value 210. In particular, it may be provided that the upper counter value 212 is at least seven eighths of the difference between maximum value 211 and minimum value 210 plus minimum value 210 and the lower counter value 213 is at most one eighth of the difference between maximum value 211 and minimum value 210 plus minimum value 210.

In order to transmit a peak power exceeding the nominal power, the upper counter value 212 is at least three quarters of the difference between the maximum value 211 and the minimum value 210 plus the minimum value 210, and the lower counter value 213 is at most one quarter of the difference between the maximum value 211 and the minimum value 210 plus the minimum value 210.

This is the case shown in FIG. 6, in which there are identical time intervals without voltage between the voltage pulses in the course of the applied coil voltage 207. In this case, there is a large effective value of the coil current 209 and thus the greatest possible energy transmission. In particular, it may be provided that for the transmission of the nominal power, the upper counter value 212 is at least seven eighths of the difference between the maximum value 211 and the minimum value 210 plus the minimum value 210 and the lower counter value 213 is at most one eighth of the difference between the maximum value 211 and the minimum value 210 plus the minimum value 210 and for the transmission of the peak power the upper counter value 212 is exactly three quarters of the difference between the maximum value 211 and the minimum value 210 plus the minimum value 210 and the lower counter value 213 is exactly one quarter of the difference between the maximum value 211 and the minimum value 210 plus the minimum value 210.

If a power exceeding the nominal power is to be transmitted which is smaller than the peak power, the upper counter value 212 is larger than three quarters of the difference of maximum value 211 and minimum value 210 plus minimum value 210 and smaller than seven eighths of the difference of maximum value 211 and minimum value 210 plus minimum value 210 and the lower counter value 213 is smaller than one quarter of the difference of maximum value 211 and minimum value 210 plus minimum value 210 and larger than one eighth of the difference of maximum value 211 and minimum value 210 plus minimum value 210.

To simplify the underlying equations, it may be provided that the minimum value 210 is defined as zero and the counter counts from zero to the maximum value 211.

The peak power exceeding the nominal power may be used in particular to transmit a higher power required for a short time, with the nominal power corresponding to a maximum power that may be transmitted in continuous operation. For example, the nominal power may correspond to a maximum of 250 watts, and the peak power may correspond to 500 watts. In particular, the nominal power may correspond to a maximum of 125 watts, and the peak power may correspond to 250 watts. Furthermore, it may be provided that the nominal power is between 10 and 50 watts, in particular 30 watts. The peak power may then be between 50 and 90 watts, in particular 70 watts.

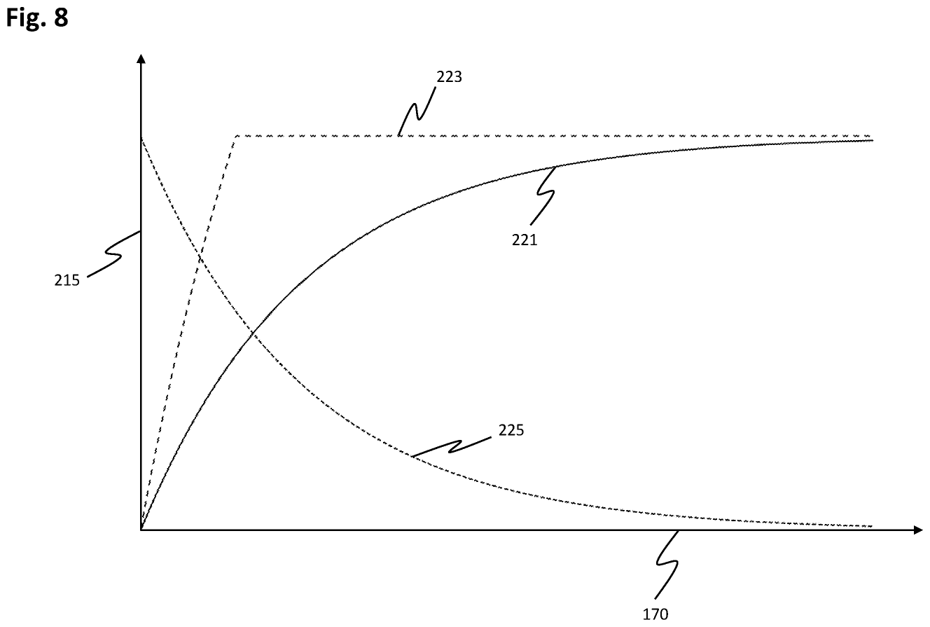

FIG. 8 shows a temperature 215 plotted over a time 170 for different switching states. In particular, the temperature 215 may be a surface temperature of the stationary unit 111 or the housing of the stationary unit 111, or the temperature of the component of the stationary unit 111 that is most sensitive to temperature.

A first temperature curve 221 corresponds to a transmission of nominal power when the energy transmission is turned on. This is followed by an exponential increase in temperature, which asymptotically approaches a maximum value corresponding to a maximum temperature at which the energy transmission may still be operated in a fail-safe manner. The maximum temperature may be derived from standards requiring that electrical equipment not exceed a certain temperature at a contactable surface, such as 105 degrees Celsius, or from predetermined operating temperatures of components of the stationary units 111. A second temperature profile 223 represents an elevated temperature in which peak power is initially transmitted and then reduced to the nominal load when the maximum temperature is reached. A third temperature profile 225 corresponds to the termination of energy transmission when the energy-transmitting coil 125 is de-energized again when the maximum temperature value was previously reached.

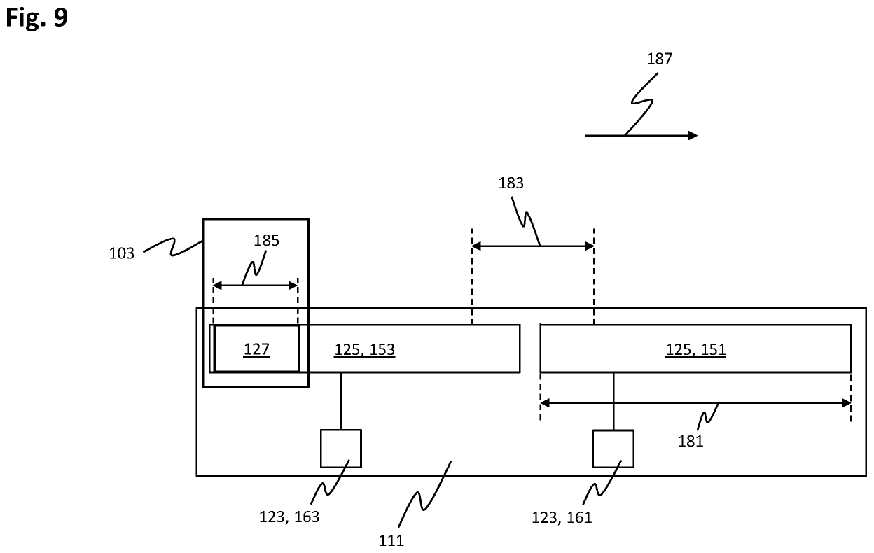

FIG. 9 shows a schematic view of a stationary unit 111, wherein the stationary unit 111 in this embodiment comprises a first energy-transmitting coil 151 and a second energy-transmitting coil 153. The stationary unit 111 further comprises a first actuation electronics 161 for actuating the first energy-transmitting coil 151 and a second actuation electronics 163 for actuating the second energy-transmitting coil 153, wherein the first actuation electronics 161 and the second actuation electronics 163 may correspond to the actuation electronics 123 described above.

Furthermore, a movable unit 103 having an energy-receiving coil 127 is shown. If the position data of the energy-receiving coil 127, which may correspond to the position data of the movable unit 103, indicates that the energy-receiving coil 127 moves from the first energy-transmitting coil 151 to the second energy-transmitting coil 153, and if the first actuation electronics 161 and the second actuation electronics 163 are synchronized based on the interrupt signal 171, this is implemented in the first actuation electronics 161 and the second actuation electronics 163 by starting the respective counters 201 simultaneously for the first actuation electronics 161 and the second actuation electronics 163 (shown in FIGS. 6 and 7 for one counter 201 each).

The energy quantity signal is output to both the first actuation electronics 161 and the second actuation electronics 163 and is respectively linked to the upper counter value 212 and the lower counter value 213, this linkage being identical for the first actuation electronics 161 and the second actuation electronics 163. The first switching curve 203 and the second switching curve 205 are then identical for both the first energy-transmitting coil 151 and the second energy-transmitting coil 153, and may be configured analogously to FIGS. 6 and 7.

A synchronous current is then applied to the first energy-transmitting coil 151 and the second energy-transmitting coil 153. If the movable unit 103 is now moved from the first energy-transmitting coil 151 to the second energy-transmitting coil 153, the synchronous energizing of the first energy-transmitting coil 151 and the second energy-transmitting coil 153 results in as little interference as possible due to the fact that the movable unit 103 moves from the first energy-transmitting coil 151 to the second energy-transmitting coil 153. The magnetic fields of the first energy-transmitting coil 151 and the second energy-transmitting coil 153 then ideally overlap in time.

As a result, the energy-receiving coil 127 receives a sum of the two fields. If the two magnetic fields of the first energy-transmitting coil 151 and the second energy-transmitting coil 153 were not synchronous, but were shifted in time, for example, they could interfere with each other or the sum of the two fields would be lower, for example, if one field was still positive and the other was already negative.

Furthermore, in this embodiment example, as described above, it may be provided that the upper counter value 212 is decreased and the lower counter value 213 is increased when the energy-receiving coil 127 is arranged between the first energy-transmitting coil 151 and the second energy-transmitting coil 153 because a decreased magnetic flux hits the energy-receiving coil 127 in a gap between the first energy-transmitting coil 151 and the second energy-transmitting coil 153, and this decreased flux may be compensated by the increased current flowing to the first energy-transmitting coil 151 and the second energy-transmitting coil 153. In this context, it may be provided that a first length 181 of the energy-transmitting coils 125 is larger than a second length 183 of a transition region and the second length 183 is larger than a third length 185 of the energy-receiving coil 127. In this regard, the first length 181, the second length 183, and the third length 185 refer to a direction of travel 187 along the guide rail 105.

Furthermore, it may be provided that a thermal load of the energy transmission is determined and a cooling-off time is calculated. A renewed reduction of the upper counter value 212 and a renewed increase of the lower counter value 213 then takes place only after the cooling-off time. In this way, it may be achieved that an overall thermal load on the energy transmission may be controlled and kept smaller than a maximum thermal load.

Provision may further be made to vary the current to the drive coils 135 so that the movable unit 103 moves faster while the movable unit 103 is moving from the first energy-transmitting coil 151 to the second energy-transmitting coil 153, so as to reduce the drive current when the movable unit 103 is in the region of the first energy-transmitting coil 151 or the second energy-transmitting coil 153. As a result, an average speed of the movable unit 103 may be kept constant and the movable unit 103 may be moved faster in the region of the transition between the first energy-transmitting coil 151 and the second energy-transmitting coil 153 to further reduce the thermal load of the system. In particular, an increase time during which the current through the drive coils 135 is increased may be calculated from a speed of the movable unit 103.

It may further be provided that the upper counter value 212 and the lower counter value 213 are adjusted based on a temperature measured in the region of the energy-transmitting coils 125. The adjustment may, in particular, reduce the thermal load on the energy transmission, at the expense of an increased thermal load on the drive coils 135. In many operating cases, however, a larger thermal reserve is available in the drive coils 135.

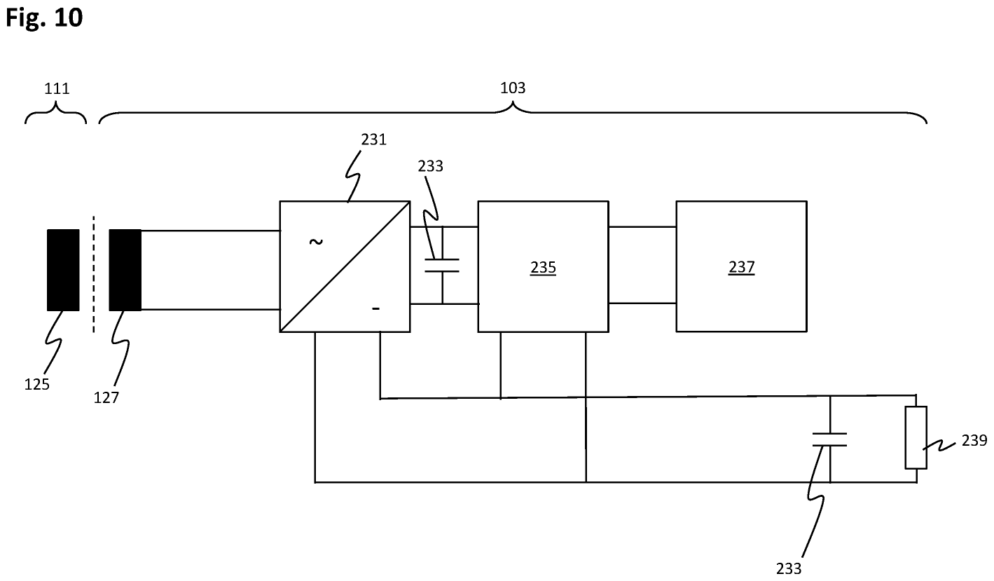

FIG. 10 shows an electrical circuit of the movable unit 103. The current transmitted with the aid of the energy-receiving coil 127 may be rectified with the aid of a rectifier 231 and then smoothed with the aid of a capacitor 233. Furthermore, a charge controller 235 is provided for an accumulator 237, wherein the charge controller 235 controls charging or discharging of the accumulator 237. Furthermore, a load 239, such as an electric motor or another tool, may serve as a current consumer. A capacitor 233 may also be arranged in the region of the load 239. In particular, only one of the capacitors 233 may be provided and the capacitor 233 may be connected in parallel with the energy receiving coil 127.

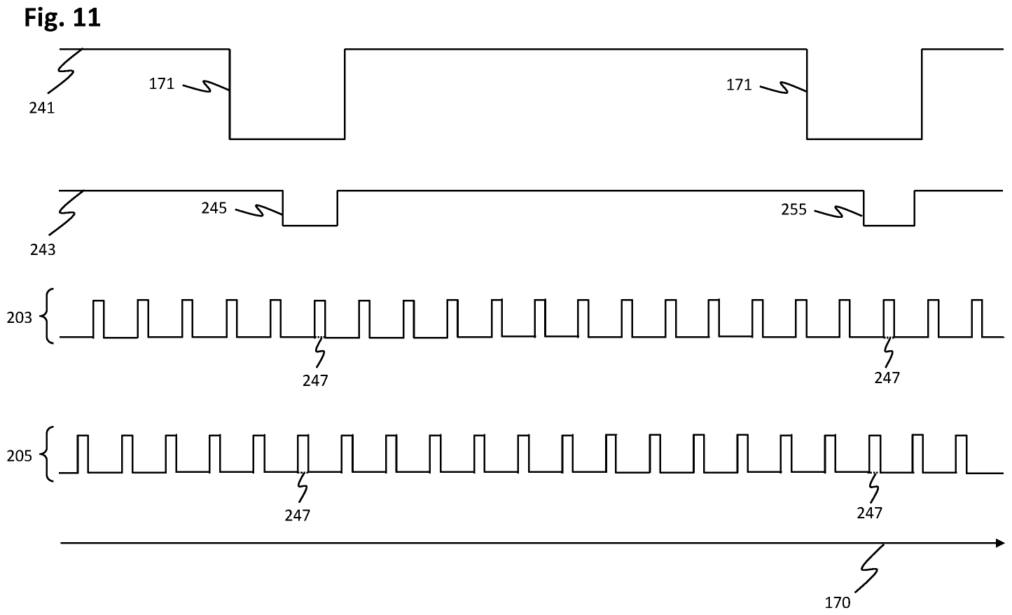

FIG. 11 shows a synchronization signal 241, a data transmission signal 243 as well as the first switching signal curve 203 and the second switching signal curve 205. The synchronization signal 241 may comprise an interrupt signal 171, from which the counters 201 of the actuation electronics 123 are started in each case. The data transmission signal 243 may comprise a data transmission edge 245, wherein at the data transmission edge 245, for example, a data transmission may be triggered with the aid of the stationary antenna 129 and the movable antenna 131.

In the event that data transmission is critical, provision may be made for omitted switching pulses 247 to be provided in the first switching curve 203 and the second switching curve 205, directly following the data transmission edge 245. This is shown by dotted lines in the first switching curve 203 and the second switching curve 205, and the switching pulse 247 shown with a dotted line may be omitted in each case. This means that although power should be supplied to the energy-transmitting coil 125 after the counter 201 or the upper counter value 212 and the lower counter value 213, no energy is transmitted due to the data transmission in order to secure the data transmission. Critical data transmissions may include, in particular, safety-critical data transmissions.

It may further be provided that position data of the energy-receiving coils 127 of the movable unit 103 are e.g. determined with the aid of the position detection element 143 and the position sensor 145. Subsequently, the energy-transmitting coil 125 within the linear transport system 101 closest to the energy-receiving coil 127 is selected. Thus, the energy-transmitting coil 125 is selected based on the position data. Then, the energy quantity signal is output to the actuation electronics 123 of the selected energy-transmitting coil 125.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals: 1-199

101 transport system
103 movable unit
105 guide rail
107 linear motor
109 stator
111 stationary unit
113 rotors
117 magnet
123 actuation electronics
125 energy-transmitting coil
126 first coil part
127 energy-receiving coil
128 second coil part
129 stationary antenna
131 movable antenna
133 controller
135 drive coil
137 tool
139 track roller
141 rolling surface
143 position detection element
145 position sensor
147 communication interface
149 coil control
150 driver
151 first energy-transmitting coil
153 second energy transmitter coil
155 third energy-transmitting coil
161 first actuation electronics
163 second actuation electronics
165 third actuation electronics
170 time
171 interrupt signal
173 header frame
175 first data frame
177 second data frame
179 third data frame
181 first length
183 second length
185 third length
187 direction of travel
190 half bridge
191 second half bridge
192 half bridge center point
193 second half bridge center
194 first switch
195 second switch
196 third switch
197 fourth switch
198 potential
199 shared ground point

TABLE 2
List of reference numerals: 201-247

201 counter
203 first switching curve
205 second switching curve
207 coil voltage
209 coil current
210 minimum value
211 maximum value
212 upper counter value
213 lower counter value
215 temperature curve
221 first temperature curve
223 second temperature curve
225 third temperature curve
231 rectifier
233 capacitor
235 charge controller
237 accumulator
239 load
241 synchronization signal
243 data transmission signal
245 data transmission edge
247 switching pulse

What is claimed is:

1. A method for transferring energy from a stationary unit to a movable unit of a linear transport system, the linear transport system comprising:
a guide rail for guiding the movable unit,
a plurality of stationary units, and
a linear motor for driving the movable unit along the guide rail, the linear motor comprising a stator and a rotor, the stator including the stationary units each comprising one or a plurality of drive coils, the rotor being arranged on the movable unit and comprising one or a plurality of magnets,
the stationary units each comprising one or a plurality of energy-transmitting coils, each energy-transmitting coil having an actuation electronics, and
the movable unit comprising at least one energy-receiving coil;
wherein the actuation electronics of the energy-transmitting coils carry out the following steps:
reading in an energy quantity signal for the relevant energy-transmitting coil;
converting the energy quantity signal into a pulse-pause ratio for actuating the energy-transmitting coil;
actuating the energy-transmitting coil based on the pulse-pause ratio.

2. The method according to claim 1, wherein converting the energy quantity signal to the pulse-to-pause ratio is carried out using counters, wherein a current through the energy-transmitting coil is controlled based on the pulse-to-pause ratio.

3. The method according to claim 2, wherein the actuation electronics comprise:
at least a first half-bridge having a first switch and a second switch and a second half-bridge having a third switch and a fourth switch,
wherein the energy-transmitting coil is arranged between a first half-bridge center and a second half-bridge center, the first half-bridge center being arranged between the first switch and the second switch, the second half-bridge center being arranged between the third switch and the fourth switch,
wherein the counter respectively counts up from a minimum value to a maximum value and then counts down from the maximum value to the minimum value, the energy quantity signal being associated with an upper counter value and a lower counter value, and
wherein the first switch and the fourth switch are rendered conductive when the counter is above the upper counter value, and the second switch and the third switch are rendered conductive when the counter is below the lower counter value.

4. The method according to claim 3, wherein the upper counter value is larger than three-fourths of a difference of the maximum value and the minimum value plus the minimum value and the lower counter value is less than one-fourth of the difference of the maximum value and the minimum value plus the minimum value when a nominal power is to be transmitted.

5. The method according to claim 4, wherein for transmitting the nominal power, the upper counter value is at least seven-eighths of the difference between the maximum value and the minimum value plus the minimum value, and the lower counter value is at most one-eighth of the difference between the maximum value and the minimum value plus the minimum value.

6. The method according to claim 4, wherein for transmitting a peak power exceeding the nominal power, the upper counter value is at least three quarters of the difference between the maximum value and the minimum value plus the minimum value, and the lower counter value is at most one quarter of the difference between the maximum value and the minimum value plus the minimum value.

7. The method according to claim 3, wherein the actuation electronics of the energy-transmitting coils carry out the following further steps:
reading in a data transmission signal from the actuation electronics, wherein the data transmission signal includes that a data transmission is taking place in the region of the energy-transmitting coil, and
wherein at least once, when the counter is above the upper counter value, the first switch and the fourth switch are switched to non-conductive, and at least once when the counter is below the lower counter value, the second switch and the third switch are switched to non-conductive.

8. The method according to claim 1, wherein a controller outputs a synchronization signal to the actuation electronics of the energy-transmitting coils and the actuation electronics synchronizes the counters using the synchronization signal.

9. The method according to claim 1, wherein the following steps are carried out by a controller:
determining position data of the energy-receiving coil of the movable unit;
selecting at least one energy-transmitting coil within the linear transport system based on position data from the energy-receiving coil; and
outputting an energy quantity signal to the actuation electronics of the selected energy-transmitting coils.

10. The method according to claim 3,
wherein the position data of the energy-receiving coil of the movable unit shows that the energy-receiving coil moves from a first energy-transmitting coil to a second energy-transmitting coil,
wherein a first actuation electronics of the first energy-transmitting coil and a second actuation electronics of the second energy-transmitting coil are each synchronized with the aid of the synchronization signal,
wherein a first counter of the first actuation electronics and a second counter of the second actuation electronics are started simultaneously on the basis of the synchronization signal, and
wherein the energy quantity signal is output to the first actuation electronics and the second actuation electronics,
the actuation electronics linking the energy quantity signal to an upper counter value and to a lower counter value,
the first switch and the fourth switch of the first actuation electronics being switched on when the counter is above the upper counter value and the second switch and the third switch of the first actuation electronics being switched on when the counter is below the lower counter value,
the first switch and the fourth switch of the second actuation electronics being switched on when the counter is above the upper counter value, and
the second switch and the third switch of the second actuation electronics being switched on when the counter is below the lower counter value.

11. The method according to claim 10, wherein, when the position data indicates that the energy-receiving coil is located between the first energy-transmitting coil and the second energy-transmitting coil, the upper counter value is reduced and the lower counter value is increased.

12. The method according to claim 11, wherein in the event that a power larger than the nominal power is to be transmitted, a thermal load of the energy transmission is determined and a cooling-off time is calculated, wherein a renewed reduction of the upper counter value and a renewed increase of the lower counter value such that a power larger than the nominal power is transmittable occurs only after the cooling-off time.

13. The method according to claim 11, wherein a current to the drive coils is changed in such a way that the movable unit moves faster.

14. The method according to claim 13, wherein an increase time period during which the energizing of the drive coils is changed is calculated from a speed of the movable unit.

15. The method according to claim 1, wherein the upper counter value and the lower counter value are adjusted based on a temperature measured in the region of the energy-transmitting coil.

16. A method for transferring energy from a stationary unit to a movable unit of a linear transport system, the linear transport system comprising:
a guide rail for guiding the movable unit,
a plurality of stationary units,
a controller, and
a linear motor for driving the movable unit along the guide rail, the linear motor comprising a stator and a rotor, the stator including the stationary units each comprising one or a plurality of drive coils, the rotor being arranged on the movable unit and comprising one or a plurality of magnets,
the stationary units each comprising one or a plurality of energy-transmitting coils, each energy-transmitting coil having an actuation electronics, the movable unit comprising at least one energy-receiving coil;
wherein the controller carries out the following steps:
detecting position data of the energy-receiving coil of the movable unit,
selecting energy-transmitting coils of the stationary units on the basis of the position data of the energy-receiving coil of the movable unit, and
outputting an energy quantity signal to the actuation electronics of the selected energy-transmitting coils;
wherein the actuation electronics of the selected energy-transmitting coils carry out the following steps:
reading in the energy quantity signal for the relevant energy-transmitting coil,
converting the energy quantity signal into a pulse-pause ratio for actuating the energy-transmitting coil with the aid of a counter, and
actuating the energy-transmitting coil based on the pulse-pause ratio in order to control a current through the energy-transmitting coil,
wherein, if the position data of the energy-receiving coil of the movable unit determined by the controller reveal that the energy-receiving coil of the movable unit moves away from a first energy-transmitting coil to a second energy-transmitting coil,
wherein the energy quantity signal is output to a first actuation electronics of the first energy-transmitting coil and to a second actuation electronics of the second energy-transmitting coil and the first actuation electronics of the first energy-transmitting coil and the second actuation electronics of the second energy-transmitting coil are each synchronized on the basis of a synchronization signal of the controller, and
wherein a first counter of the first actuation electronics and a second counter of the second actuation electronics are started simultaneously on the basis of a synchronization signal.

17. A linear transport system comprising:
at least one stationary unit and at least one movable unit, and
a controller;
wherein the linear transport system comprises a guide rail for guiding the movable unit, a plurality of stationary units, and a linear motor for driving the movable unit along the guide rail, the linear motor comprising a stator and a rotor,
the stator comprising the stationary units, each comprising one or a plurality of drive coils,
the rotor being arranged on the movable unit and comprising one or a plurality of magnets, and
the stationary units each comprising one or a plurality of energy-transmitting coils, each energy-transmitting coil comprising an actuation electronics, the movable unit comprising at least one energy-receiving coil;
wherein the controller is configured to:
determine position data of the energy-receiving coil of the movable unit,
select energy-transmitting coils of the stationary units on the basis of the position data of the energy-receiving coil of the movable unit, and
output an energy quantity signal to the actuation electronics of the selected energy-transmitting coils,
the actuation electronics being configured to:
read in an energy quantity signal for the relevant energy-transmitting coil,
convert the energy quantity signal it into a pulse-pause ratio, and
actuate the energy-transmitting coil on the basis of the pulse-pause ratio in order to control a current through the energy-transmitting coil,
wherein, if the position data of the energy-receiving coil of the movable unit determined by the controller reveal that the energy-receiving coil of the movable unit moves away from a first energy-transmitting coil to a second energy-transmitting coil,
wherein the energy quantity signal is output to a first actuation electronics of the first energy-transmitting coil and to a second actuation electronics of the second energy-transmitting coil and the first actuation electronics of the first energy-transmitting coil and the second actuation electronics of the second energy-transmitting coil are each synchronized on the basis of a synchronization signal of the controller, and
wherein a first counter of the first actuation electronics and a second counter of the second actuation electronics are started simultaneously on the basis of a synchronization signal.

18. The linear transport system according to claim 17, wherein the actuation electronics comprises:
at least a first half bridge having a first switch and a second half bridge having a third switch and a fourth switch,
wherein the energy-transmitting coil is arranged between a first half-bridge center and a second half-bridge center,
wherein the first half-bridge center is arranged between the first switch and the second switch,
wherein the second half-bridge center is arranged between the third switch and the fourth switch,
wherein the counter in each case counts up from a minimal value to a maximum value and subsequently counts down from a maximum value to a minimal value,
wherein the energy quantity signal is linked to an upper counter value and to a lower counter value, and
wherein the first switch and the fourth switch are switched to conductive if the counter is above the upper counter value and the second switch and the third switch are switched to conductive if the counter is below the lower counter value.

19. The linear transport system according to claim 18, wherein, if the position data reveal that the energy-receiving coil is arranged between the first energy-transmitting coil and the second energy-transmitting coil, the upper counter value is reduced and the lower counter value is increased.

20. The linear transport system according to claim 18, wherein the upper counter value and the lower counter value are adjusted on the basis of a temperature measured in the region of the energy-transmitting coil.
